(19) United States
(12) Patent Application Publication
(10) Pub. No.: US 2020/0131601 A1
(43) Pub. Date: Apr. 30, 2020

(54) ON-LINE ALUMINUM SCRAP REMELTING DEVICE AND PROCESS

(71) Applicant: CITIC Dicastal CO., LTD, Qinhuangdao (CN)

(72) Inventors: Zhiliang ZHANG, Qinhuangdao (CN); Zhiqiang LU, Qinhuangdao (CN); Yang LIU, Qinhuangdao (CN); Xinghua LIU, Qinhuangdao (CN)

(73) Assignee: CITIC Dicastal CO., LTD, Qinhuangdao (CN)

(21) Appl. No.: 16/407,696

(22) Filed: May 9, 2019

(30) Foreign Application Priority Data
Oct. 31, 2018 (CN) 201811288384.6

(51) Int. Cl. C22B 21/00; F27B 7/20

(52) U.S. Cl. CPC C22B 21/0092; F27B 7/2083

(57) ABSTRACT

The present application discloses an on-line aluminum scrap remelting device, comprising an aluminum scrap conveying device, a primary aluminum scrap purification device, a remote aluminum scrap transport device, an ultimate aluminum scrap purification device, and a feed remelting device. The application further discloses an on-line aluminum scrap remelting process, comprises machined scrap removal, underground aluminum scrap transport collection, temporary storage, crushing, spin-drying, remote transport, secondary magnetic separation, drying, weighing, remelting, tempering, and use.

### CROSS-REFERENCE TO RELATED APPLICATIONS

This application claims priority to Chinese Patent Application No. 201811288384.6, filed on Oct. 31, 2018, which is hereby incorporated by reference in its entirety.

### TECHNICAL FIELD

The present application relates to an on-line aluminum scrap remelting device, relating to the field of aluminum alloy casting production.

### BACKGROUND ART

The aluminum alloy casting manufacturing process includes aluminum alloy solution smelting, casting molding and machining, while the machining produces a large amount of aluminum scraps. At present, the machined aluminum scraps of most enterprises are sold, which causes a great waste in cost. The aluminum scraps in some enterprises are remelted. Since the aluminum scraps contain a large amount of emulsion, water and other impurities, the melting process produces a lot of dense smoke, and increases the hydrogen content and the slag content of the molten aluminum in the furnace, so that the quality of molten aluminum is uncontrollable.

### SUMMARY OF THE INVENTION

In view of the above deficiencies in the prior art, the present application provides an on-line aluminum scrap remelting device for on-line treatment and then remelting of machined aluminum scraps. The process may treat the aluminum scraps thoroughly to ensure the quality of molten aluminum, and may realize zero reproduction to greatly reduce the operating cost.

An on-line aluminum scrap remelting device includes an aluminum scrap conveying device, a primary aluminum scrap purification device, a remote aluminum scrap transport device, an ultimate aluminum scrap purification device, and a feed remelting device.

The underground aluminum scrap conveying, collection and temporary storage link uses the aluminum scrap conveying device, a trench is arranged around a machining area, the aluminum scrap conveying device is arranged in the trench, each machining lathe scrap discharging machine is directly connected to the aluminum scrap conveying device, a temporary storage tank is arranged at the tail end of the aluminum scrap conveying device, and aluminum scraps are temporarily stored in the temporary storage tank.

The crushing and drying link uses the primary aluminum scrap purification device includes an aluminum scrap crushing device, a spin dryer, a first scrap hoist and a second scrap hoist, wherein the aluminum scrap crushing device includes a primary coarse magnetic separator and an aluminum scrap crusher, a discharge port of the primary coarse magnetic separator is connected to a feed port of the aluminum scrap crusher, the first scrap hoist is arranged between the temporary storage tank and the aluminum scrap crushing device, a discharge port of the temporary storage tank is correspondingly connected to a feed port at the lower end of the first scrap hoist, and a discharge port at the upper end of the first scrap hoist is correspondingly connected to a feed port of the primary coarse magnetic separator; the second scrap hoist is arranged between the aluminum scrap crushing device and the spin dryer, a discharge port of the aluminum scrap crusher is correspondingly connected to the feed port at the lower end of the second scrap hoist, and the discharge port at the upper end of the second scrap hoist is correspondingly connected to a feed port of the spin dryer.

The remote transport uses the remote aluminum scrap transport device includes a pneumatic mechanism and a transport pipe, the pneumatic mechanism adopts a venturi structure and includes a blower, an air supply pipe, a discharge pipe and a vacuum chamber, and the remote aluminum scrap transport device remotely transports aluminum scraps to a melting equipment area.

The secondary magnetic separation and drying use the ultimate aluminum scrap purification device includes a secondary magnetic separator and a rotary kiln, a feed port of the secondary magnetic separator is connected to a discharge port of the transport pipe of the remote aluminum scrap transport device, and a discharge port of the secondary magnetic separator is connected to a feed port of the rotary kiln.

The remelting uses the feed remelting device includes a smelting furnace and a feed mechanism connected between a discharge port of the rotary kiln and the smelting furnace.

Further, the aluminum scrap conveying device is any one of a screw conveyor and a shark thorn conveyor.

Further, a scrap hoist is arranged between the aluminum scrap conveying device and the temporary storage tank.

Further, a blower outlet of the remote aluminum scrap transport device is connected with the air supply pipe, and radius of an end of the air supply pipe is reduced to form a nozzle, the vacuum chamber is arranged at the junction of the air supply pipe, a discharge pipe and the transport pipe, the axes of the starting ends of the air supply pipe and the transport pipe coincide to reduce the wind resistance, and the nozzle at the tail end of the air supply pipe is located at the bottom of a discharge port of the discharge pipe in the vacuum chamber.

Further, in the feed remelting device, a vortex well is arranged on one side of the smelting furnace, the end of the feed mechanism and the vortex well are correspondingly arranged, and the dried aluminum scraps or aluminum scrap blocks are directly immersed in the molten aluminum.

An on-line aluminum scrap remelting process includes: machined scrap removal, underground aluminum scrap transport collection, temporary storage, crushing, spin-drying, remote transport, secondary magnetic separation, drying, weighing, remelting, tempering, and use.

The application provides an on-line aluminum scrap remelting process adopting automatic continuous operation, after being crushed, spin-dried and various stages of purification, the machined aluminum scraps are remelted, thereby greatly reducing the slag content of molten aluminum scrap, ensuring the quality of the molten aluminum, at the same time, realizing zero reproduction of aluminum scraps, and greatly reducing the operating cost.

### BRIEF DESCRIPTION OF DRAWINGS

FIG. 1 is a diagram of a device according to the present application;

FIG. 2 is a structure diagram of a pneumatic mechanism.

In figures: 1—aluminum scrap conveying device, 2—third scrap hoist, 3—storage tank, 4—first scrap hoist, 5—primary coarse magnetic separator, 6—aluminum scrap crusher, 7—second scrap hoist, 8—spin dryer, 9—pneumatic mechanism, 10—transport pipe, 11—secondary magnetic separator, 12—rotary kiln, 13—feed mechanism, 14—vortex well, 15—smelting furnace; 901—blower, 902—air supply pipe, 903—nozzle, 904—vacuum chamber, 905—discharge pipe.

### DETAILED DESCRIPTION OF THE INVENTION

The present application will be further illustrated below in combination with specific embodiments and drawings.

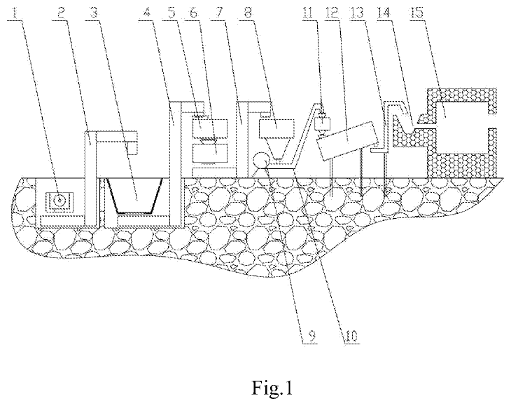

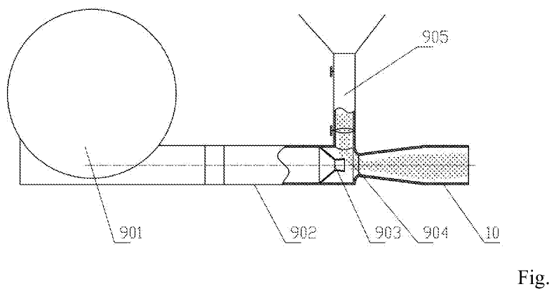

As shown in FIG. 1 and FIG. 2, an on-line aluminum scrap remelting device comprises an aluminum scrap conveying device, a primary aluminum scrap purification device, a remote aluminum scrap transport device, an ultimate aluminum scrap purification device, and a feed remelting device.

The underground aluminum scrap conveying, collection and temporary storage link uses the aluminum scrap conveying device, a trench is arranged around a machining area, the aluminum scrap conveying device 1 is arranged in the trench and is any one of a screw conveyor and a shark thorn conveyor, each machining lathe scrap discharging machine is directly connected to the aluminum scrap conveying device 1, a storage tank 3 is arranged at the tail end of the aluminum scrap conveying device 1, aluminum scraps are temporarily stored in the storage tank 3, and a third scrap hoist 2 is arranged between the aluminum scrap conveying device 1 and the storage tank 3.

The crushing and drying link uses the primary aluminum scrap purification device comprising an aluminum scrap crushing device, a spin dryer and scrap hoists, wherein the aluminum scrap crushing device comprises a primary coarse magnetic separator 5 and an aluminum scrap crusher 6, a discharge port of the primary coarse magnetic separator 5 is connected to a feed port of the aluminum scrap crusher 6, the first scrap hoist 4 is arranged between the temporary storage tank 3 and the aluminum scrap crushing device, a discharge port of the temporary storage tank 3 is correspondingly connected to a feed port at the lower end of the first scrap hoist 4, and a discharge port at the upper end of the first scrap hoist 4 is correspondingly connected to a feed port of the primary coarse magnetic separator; the second scrap hoist 7 is arranged between the aluminum scrap crusher 6 and the spin dryer 8, a discharge port of the aluminum scrap crusher 6 is correspondingly connected to the feed port at the lower end of the second scrap hoist 7, and the discharge port at the upper end of the second scrap hoist 7 is correspondingly connected to a feed port of the spin dryer 8.

The remote transport uses the remote aluminum scrap transport device comprising a pneumatic mechanism 9 and a transport pipe 10, the pneumatic mechanism 9 adopts a venturi structure and comprises a blower 901, an air supply pipe 902, a discharge pipe 905 and a vacuum chamber 904, the outlet of the blower 901 is connected to the air supply pipe 902, and radius of the end of the air supply pipe is reduced to form a nozzle 903, the vacuum chamber 904 is arranged at the junction of the air supply pipe 902, the discharge pipe 905 and the transport pipe 10, the axes of the starting ends of the air supply pipe 902 and the transport pipe 10 coincide to reduce wind resistance and save energy, and the nozzle 903 is located at the bottom of a discharge port of the discharge pipe 905 in the vacuum chamber 904.

The secondary magnetic separation and drying use the ultimate aluminum scrap purification device comprising a secondary magnetic separator 11 and a rotary kiln 12, a feed port of the secondary magnetic separator 11 is connected to a discharge port of the transport pipe 10 of the remote aluminum scrap transport device, and a discharge port of the secondary magnetic separator 11 is connected to a feed port of the rotary kiln 12.

The remelting uses the feed remelting device comprising a smelting furnace 15 and a feed mechanism 13 connected between a discharge port of the rotary kiln 12 and the smelting furnace 15, a vortex well 14 is arranged on one side of the smelting furnace 15, the end of the feed mechanism 13 and the vortex well 14 are correspondingly arranged, and the dried aluminum scraps or aluminum scrap blocks are directly immersed in the molten aluminum to reduce the burnout rate.

The foregoing descriptions of specific exemplary embodiments of the present application have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An on-line aluminum scrap remelting device, comprising an aluminum scrap conveying device, a primary aluminum scrap purification device, a remote aluminum scrap transport device, an ultimate aluminum scrap purification device, and a feed remelting device, wherein
the aluminum scrap conveying device indicates that a trench is arranged around a machining area, the aluminum scrap conveying device is arranged in the trench, each machining lathe scrap discharging machine is directly connected to the aluminum scrap conveying device, a temporary storage tank is arranged at the tail end of the aluminum scrap conveying device, and aluminum scraps are temporarily stored in the temporary storage tank;
the primary aluminum scrap purification device comprises an aluminum scrap crushing device, a spin dryer, a first scrap hoist and a second scrap hoist, wherein the aluminum scrap crushing device comprises a primary coarse magnetic separator and an aluminum scrap crusher, a discharge port of the primary coarse magnetic separator is connected to a feed port of the aluminum scrap crusher, the first scrap hoist is arranged between the temporary storage tank and the aluminum scrap crushing device, a discharge port of the temporary storage tank is correspondingly connected to a feed port at the lower end of the first scrap hoist, and a discharge port at the upper end of the first scrap hoist is correspondingly connected to a feed port of the primary coarse magnetic separator; the second scrap hoist is arranged between the aluminum scrap crushing device and the spin dryer, a discharge port of the aluminum scrap crusher is correspondingly connected to the feed port at the lower end of the second scrap hoist, and the discharge port at the upper end of the second scrap hoist is correspondingly connected to a feed port of the spin dryer;
the remote aluminum scrap transport device comprises a pneumatic mechanism and a transport pipe, wherein the pneumatic mechanism adopts a venturi structure and comprises a blower, an air supply pipe, a discharge pipe and a vacuum chamber;
the ultimate aluminum scrap purification device comprises a secondary magnetic separator and a rotary kiln, a feed port of the secondary magnetic separator is connected to a discharge port of the transport pipe of the remote aluminum scrap transport device, and a discharge port of the secondary magnetic separator is connected to a feed port of the rotary kiln; and
the feed remelting device comprises a smelting furnace and a feed mechanism connected between a discharge port of the rotary kiln and the smelting furnace.

2. The on-line aluminum scrap remelting device according to claim 1, wherein that the aluminum scrap conveying device is a screw conveyor.

3. The on-line aluminum scrap remelting device according to claim 1, wherein that the aluminum scrap conveying device is a shark thorn conveyor.

4. The on-line aluminum scrap remelting device according to claim 1, wherein that a third scrap hoist is arranged between the aluminum scrap conveying device and the temporary storage tank.

5. The on-line aluminum scrap remelting device according to claim 1, wherein that a blower outlet of the remote aluminum scrap transport device is connected with the air supply pipe, and radius of an end of the air supply pipe is reduced to form a nozzle, the vacuum chamber is arranged at the junction of the air supply pipe, a discharge pipe and the transport pipe, the axes of the starting ends of the air supply pipe and the transport pipe coincide, and the nozzle at the tail end of the air supply pipe is located at the bottom of a discharge port of the discharge pipe in the vacuum chamber.

6. The on-line aluminum scrap remelting device according to claim 1, wherein that in the feed remelting device, a vortex well is arranged on one side of the smelting furnace, and the end of the feed mechanism and the vortex well are correspondingly arranged.

7. An on-line aluminum scrap remelting process, comprising machined scrap removal, underground aluminum scrap transport collection, temporary storage, crushing, spin-drying, remote transport, secondary magnetic separation, drying, weighing, remelting, tempering, and use.
